(19) United States
(12) Patent Application Publication
(10) Pub. No.: US 2024/0398198 A1
(43) Pub. Date: Dec. 5, 2024

(54) Cleaning Wipe Tool and Method of Using Same

(71) Applicant: KICTeam, Inc., Auburn, ME (US)

(72) Inventor: John Condon, Sumner, ME (US)

(21) Appl. No.: 18/734,014

(22) Filed: Jun. 5, 2024

Related U.S. Application Data
(60) Provisional application No. 63/506,179, filed on Jun. 5, 2023.

(51) Int. Cl. A47L 13/50

(52) U.S. Cl. CPC A47L 13/50

(57) ABSTRACT

A cleaning tool comprises a handle and a tube that extends from the handle. The tube includes an opening that leads to an interior chamber. A cleaning wipe is partially inserted into the chamber and partially positioned outside of the tube. During use, the chamber holds the wipe in place while the portion of the wipe that is outside of the tube cleans an item.

### RELATED APPLICATIONS AND CLAIM OF PRIORITY

This patent document claims priority to U.S. Provisional Patent Application No. 63/506,179, filed Jun. 5, 2023, the disclosure of which is fully incorporated into this document.

### BACKGROUND

Many devices and products include cavities in which dust and debris may collect. For example, many electromechanical systems include connectors, receptacles, dispensing paths, and/or other components with openings of various sizes. As such systems are used the openings can become dirty, which in some cases can interfere with operation of the systems.

Cleaning such openings can be challenging, especially when they are relatively small or difficult to reach. Cotton-tipped cleaning swabs are sometimes useful in such situations, but cleaning swabs are sometimes too small to fully clean an opening, and swabs must be fully disposed and replaced after each use. Rags and wipes can sometimes be inserted into the opening, but only if the opening is easy to reach, and even if the opening can be reached the wipe may miss dirt that collects in the opening's corners.

This document describes new tools for use in addressing some or all of the issues described above.

### SUMMARY

In some embodiments, this disclosure describes a cleaning tool comprising a handle and a tube that extends from the handle at a first end of the tube. The tube includes an opening that leads to an interior chamber at a second end that is opposite the first end of the tube. The tool also includes or is used with a cleaning wipe.

In some embodiments, the wipe includes a first section and a second section so that, during use of the cleaning tool, the first section is positioned and compressed inside of the chamber to secure the wipe in place, and the second section is positioned outside of the tube and is usable to clean a cavity of an item. Optionally, the first section of the wipe may be a central area of the wipe, and the second section of the wipe may surround the first section.

In some embodiments, the cleaning tool further comprises an insertion tool comprising a pin having a width than is sized to fit within the opening. Optionally, in such embodiments the tube may extend from a first handle end of the handle, and the handle also may comprise a second handle end comprising an opening leading to a storage receptacle that is sized and configured to receive and store the insertion tool. Optionally, the insertion tool also comprises a base, and when the storage receptacle receives and stores the insertion tool, at least a portion of the base remains outside of the receptacle.

In some embodiments, the tube is integral with the handle. In other embodiments, the tube is separably connected to the handle.

Optionally, the tube may be less rigid than the handle.

In various options, the wipe may comprise a microfiber cloth, an unbroken loop material, or a sheet of polyester, polypropylene, cotton, wood pulp, or rayon fibers. In other embodiments, the wipe comprises a spunbonded, non-woven polyester or polypropylene fabric with a continuous filament construction.

Some embodiments described below include a kit comprising the cleaning tool of any of the embodiments described above wherein the tube is removably attached to the handle. The kit will include one or more additional tubes, wherein each of the tubes differs from the other tubes in length and/or opening size. Optionally, the kit may comprise a plurality of insertion tools, each of which comprises a pin sized to fit within at least one of the tubes.

Some embodiments described below include a method of using a cleaning tool of any of the embodiments described above. The method includes grasping a handle of the cleaning tool, and then inserting a first section of a cleaning wipe through the opening and into the chamber in an amount sufficient to secure the secure the wipe in place during use, while leaving a second section of the wipe positioned outside of the tube. The method then includes applying the second section of the wipe to an item to clean the item. Optionally, applying the second section of the wipe to the item comprises inserting the wipe and the second end of the tube into a chamber of the item. Also optionally, inserting the first section of the wipe through the opening and into the chamber may comprise using a pin of the insertion tool to push the first section of the wipe into the chamber.

### BRIEF DESCRIPTION OF THE DRAWINGS

FIG. 1 is a perspective view of an example cleaning wipe tool with a cleaning wipe.

FIG. 2 illustrates a side view of the cleaning wipe tool, with an insertion component removed from the tool's handle.

FIG. 3 illustrates the cleaning wipe tool just before a wipe is attached to the tool.

FIG. 4 illustrates the cleaning wipe tool as a wipe is attached to the tool.

FIG. 5 illustrates the cleaning wipe tool in use for cleaning a cavity of an item.

FIG. 6 illustrates the cleaning wipe tool with a wipe attached to it, in which the wipe is relatively larger than that depicted in FIGS. 1-5.

FIG. 7 also illustrates the cleaning wipe tool in use for cleaning a cavity of an item.

### DETAILED DESCRIPTION

The following description is made for the purpose of illustrating the general principles of the present devices and/or methods and is not meant to limit the inventive concepts claimed in this document. Further, particular features described in this document can be used in combination with other described features in each of the various possible combinations and permutations.

Unless otherwise specifically defined in this document, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used herein, the term “comprising” means “including, but not limited to”.

In this document, position-identifying terms such as “above”, “below”, “front”, “rear”, “side”, “top”, and “bottom” are not intended to limit the invention to a particular direction or orientation, but instead are only intended to denote relative positions, or positions corresponding to directions shown when a cleaning tool is oriented as shown in the Figures.

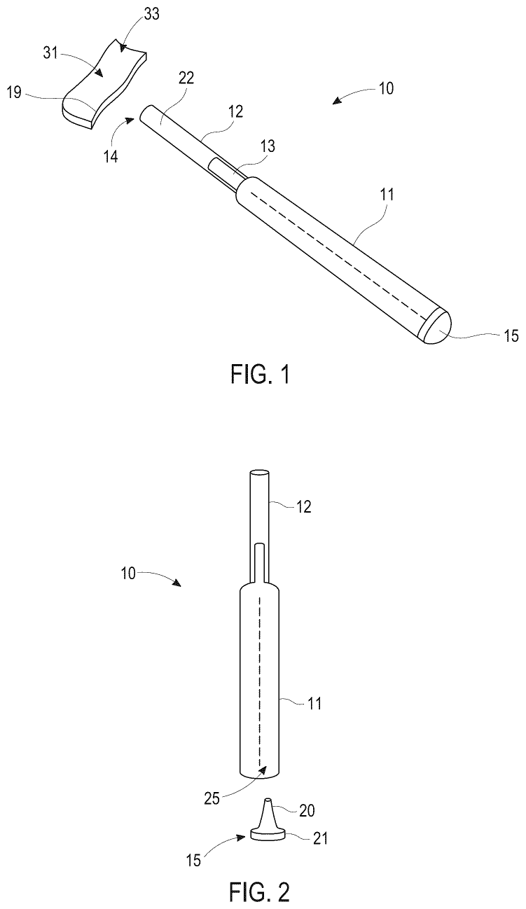

Referring to FIGS. 1-5, a cleaning tool 10 in accordance with an aspect of the disclosure is illustrated. The cleaning tool 10 includes a handle 11 and a tube 12 having two ends. The first tube end of the tube 12 extends from the handle 11. The second tube end of the tube 12 is opposite the first tube end and includes an opening 14 that leads to an interior chamber 22. The tube 12 and interior chamber 22 may be cylindrical (as with a pipe), or in the shape of a cuboid, a rectangular prism, a hexagonal prism, an octagonal prism, or any other shape.

The handle 11 and tube 12 may be integrally formed, or they may be separable from each other. For example, one end of the handle 11 may have a post 13 having a width that is approximately the same as or slightly smaller than the width of the interior chamber 22, and the tube 12 may be positioned over the post 13 so that the post 13 enters the tube's interior chamber 22 and secures the tube 12 to the handle 11 by a friction fit. The handle 11 and tube 12 may be formed of the same materials or different materials. If formed of different materials, optionally the tube 12 is formed of a material that is less rigid than that of the handle 11, such as two plastics having different stiffnesses. In this way, during use the handle 11 can be held firmly while the tube 12 is at least partially flexible and can move within a various spaces and paths.

A cleaning wipe 19 is used with the tool. The cleaning wipe 19 may be formed of any now or hereafter known woven or nonwoven material, such as a microfiber cloth, an unbroken loop material, or a sheet of polyester, polypropylene, cotton, wood pulp, or rayon fibers. In some embodiments, the wipe may be formed of a soft yet abrasive cloth, such as the spunbonded, non-woven polyester or polypropylene fabric with a continuous filament construction such as that known as REEMAY, or without a continuous filament construction such as that known as HOLLYTEX. The cleaning wipe 19 may be dry, or it may be moistened with water and/or cleaning agents such as a bleach or an alcohol-free cleaning solution. The wipe 19 includes a first section 31 that will be inserted into the chamber 22 of the tube 12 and second section 33 that will remain outside of the tube 12. Optionally, the first section 31 is a central area of the wipe and the second section 33 surrounds the first section 31.

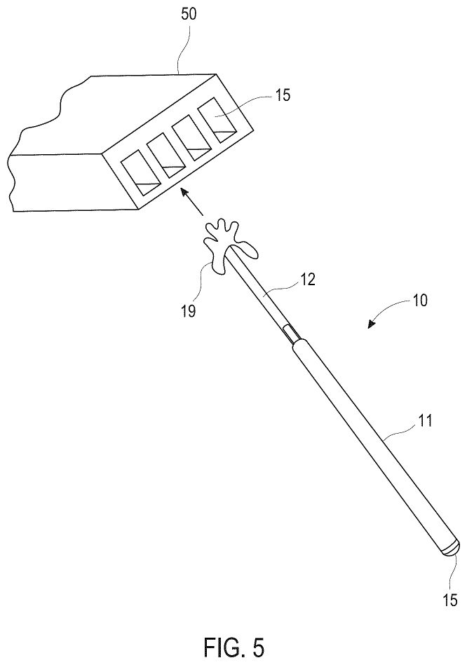

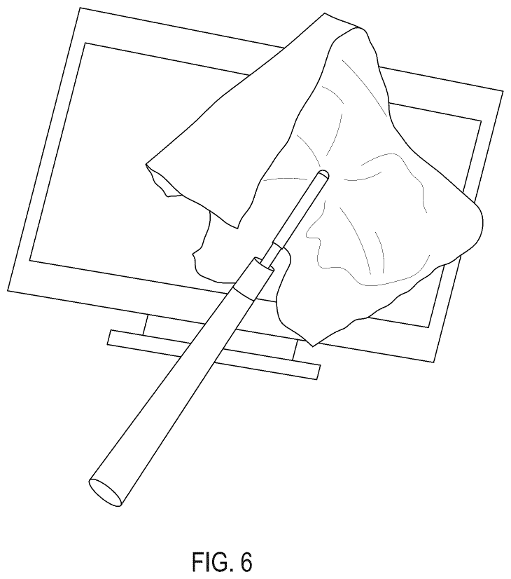

During use of the cleaning tool 10, the first section 31 of the wipe 19 is positioned inside of and compressed within the chamber 22 of the tube 12 to secure the wipe 19 in place. The second section 33 of the wipe 19 is positioned outside of the tube 12 and is usable to clean a cavity 51 of an item 50 (see FIGS. 5 and 7).

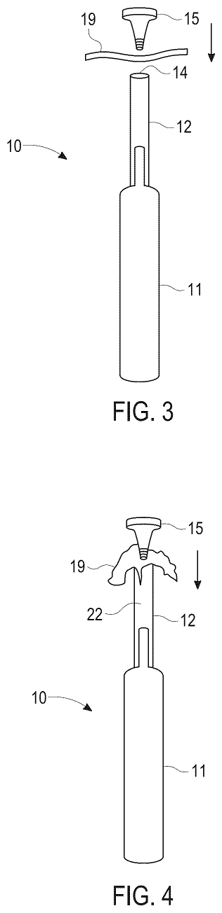

In some embodiments, the cleaning tool may include an insertion tool 15. The insertion tool 15 includes a pin 20 having a width than is sized to fit within the opening 14 of the tube 12. Optionally, the insertion tool also may include a base 21 that is attached to the pin 20. To secure the wipe 19 within the tube 12, as shown in FIG. 3 the wipe 19 may be positioned over the opening 14 of the tube 12, and the insertion tool 15 may be positioned over the wipe. Then, as shown in FIG. 4, the pin 20 of the insertion tool 15 may push the wipe 19 through the opening and into the chamber 22 to a depth that is sufficient to secure the first section 31 of the wipe 19 in place while leaving the second section 33 of the wipe outside of the tube 12.

Optionally, as shown in FIGS. 1 and 2, an end of the handle 11 that is opposite the tube 12 may include an opening leading to a storage receptacle 25 that is sized and configured to receive and store the insertion tool 15. For example, the storage receptable 25 may hold the pin 20 in place by a snap-fit or friction fit, or the storage receptable and pin 20 or base 21 may be compatibly threaded. Then, when the storage receptacle 25 receives and stores the insertion tool, at least a portion of the base 21 of the insertion tool 15 remains outside of the receptacle.

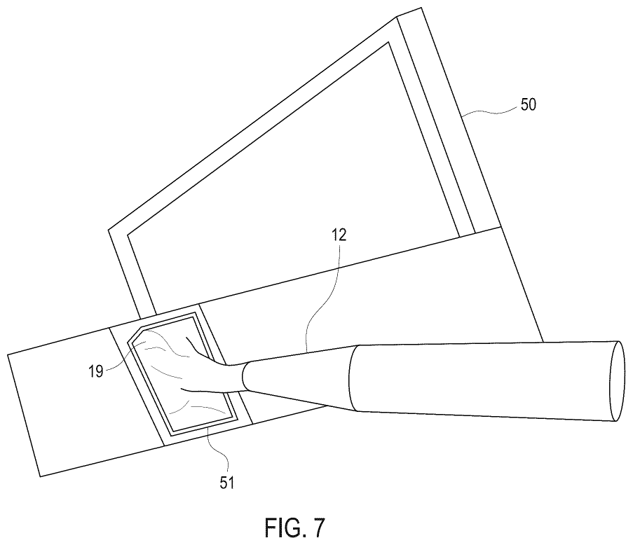

In some embodiment, the cleaning tool described above may be provided as a kit that includes multiple tubes 12, each of which can be removably attached to the handle 11. The tubes will differ from each other in length and/or opening size to allow the tubes to be selected for the required location of use and/or wipe size. Optionally, the kit may include multiple insertion tools 15, each of which includes a pin 20 sized to fit within at least one of the tubes. The kit also may include different wipes having different sizes, shapes and/or thicknesses. For example, FIG. 6 shows a wipe that is larger than that shown in FIG. 5.

To use the cleaning tool, a user may grasp the handle and insert a first section of a cleaning wipe through the opening and into the chamber in an amount sufficient to secure the secure the wipe in place during use, while leaving a second section of the wipe positioned outside of the tube. The user may then apply the second section of the wipe to an item to clean the item. For example, as shown in FIG. 7, applying the second section of the wipe to the item may include inserting the wipe and the second end of the tube into a chamber of the item, as shown in FIG. 7. Applications of the tools may include, for example: cleaning a USB or other peripheral port of a computing device or other electronic device; cleaning the interior of a card reading device such as a credit card reader or ATM machine; cleaning the interior of a lock; or other applications.

Various embodiments disclosed in this document are further illustrated by the following clauses:

Clause 1: A cleaning tool comprising: a handle; a tube that extends from the handle at a first end of the tube, wherein the tube includes an opening that leads to an interior chamber at a second end that is opposite the first end; and a cleaning wipe.

Clause 2: The cleaning tool of clause 1, wherein the wipe includes a first section and a second section so that, during use of the cleaning tool: the first section is positioned and compressed inside of the chamber to secure the wipe in place; and the second section is positioned outside of the tube and is usable to clean a cavity of an item.

Clause 3: The cleaning tool of clause 2, wherein the first section of the wipe is a central area of the wipe, and the second section of the wipe surrounds the first section.

Clause 4: The cleaning tool of any of clauses 1-4, 1 further comprising an insertion tool comprising a pin having a width than is sized to fit within the opening.

Clause 5: The cleaning tool of clause 4, wherein: the tube extends from a first handle end of the handle, and the handle also comprises a second handle end comprising an opening leading to a storage receptacle that is sized and configured to receive and store the insertion tool.

Clause 6: The cleaning tool of clause 5, wherein: (a) the insertion tool also comprises a base; and (b) the storage receptacle is configured so that, when the storage receptacle receives and stores the insertion tool, at least a portion of the base remains outside of the storage receptacle.

Clause 7: The cleaning tool of any of clauses 1-6, wherein the tube is integral with the handle.

Clause 8: The cleaning tool of any of clauses 1-6, wherein the tube is less rigid than the handle.

Clause 9: The cleaning tool of any of clauses 1-8, wherein the wipe comprises a microfiber cloth, an unbroken loop material, or a sheet of polyester, polypropylene, cotton, wood pulp, or rayon fibers.

Clause 10: The cleaning tool of any of clauses 1-8, wherein the wipe comprises a spunbonded, non-woven polyester or polypropylene fabric with a continuous filament construction.

Clause 11: A kit comprising: (a) the cleaning tool of any of clauses 1-10, wherein the tube is removably attached to the handle; and (b) one or more additional tubes, wherein each of the tubes differs from the other tubes in length and/or opening size.

Clause 12: The kit of clause 11, wherein each of the tubes is less rigid than the handle.

Clause 13: The kit of clause 11 or 12, further comprising a plurality of insertion tools, each of which comprises a pin sized to fit within at least one of the tubes.

Clause 14: The kit of clause 13, wherein: (a) the handle includes a first handle end for receiving each of the tubes; and (b) the handle also comprises a second handle end comprising an opening leading to a storage receptacle that is sized and configured to receive and store any of the insertion tools.

Clause 15: The kit of clause 14, wherein (a) each insertion tool also comprises a base; and (b) the storage receptacle is configured so that, when the storage receptacle receives and stores any of the insertion tools, at least a portion of the base of that insertion tool remains outside of the storage receptacle.

Clause 16: The kit of any of clauses 11-15, wherein the wipe comprises a microfiber cloth, an unbroken loop material, or a sheet of polyester, polypropylene, cotton, wood pulp, or rayon fibers.

Clause 17: The kit of any of clauses 11-15, wherein the wipe comprises a spunbonded, non-woven polyester or polypropylene fabric with a continuous filament construction.

Clause 18: A method of using a cleaning tool, the method comprising: (a) grasping a handle of the cleaning tool of any of clauses 1-10: (b) inserting a first section of the cleaning wipe through the opening and into the chamber in an amount sufficient to secure the secure the wipe in place during use, while leaving a second section of the wipe positioned outside of the tube; and (c) applying the second section of the wipe to an item to clean the item.

Clause 19: The method of claim 18, wherein applying the second section of the wipe to the item comprises inserting the wipe and the second end of the tube into a chamber of the item.

Clause 20: The method of clause 19, wherein: (a) the first section of the wipe is a central area of the wipe; (b) the second section of the wipe surrounds the first section; and (c) inserting the first section of the wipe through the opening and into the chamber comprises using a pin of an insertion tool to push the first section of the wipe into the chamber.

The features and functions described above, as well as alternatives, may be combined into many other different systems or applications. Various alternatives, modifications, variations or improvements may be made by those skilled in the art, each of which is also intended to be encompassed by the disclosed embodiments.

1. A cleaning tool, comprising:
a handle;
a tube that:
extends from the handle at a first end of the tube, and
includes an opening that leads to an interior chamber at a second end that is opposite the first end; and
a cleaning wipe.

2. The cleaning tool of claim 1, wherein the wipe includes a first section and a second section so that, during use of the cleaning tool:
the first section is positioned and compressed inside of the chamber to secure the wipe in place; and
the second section is positioned outside of the tube and is usable to clean a cavity of an item.

3. The cleaning tool of claim 2, wherein:
the first section of the wipe is a central area of the wipe; and
the second section of the wipe surrounds the first section.

4. The cleaning tool of claim 1 further comprising an insertion tool comprising a pin having a width than is sized to fit within the opening.

5. The cleaning tool of claim 4, wherein:
the tube extends from a first handle end of the handle; and
the handle also comprises a second handle end comprising an opening leading to a storage receptacle that is sized and configured to receive and store the insertion tool.

6. The cleaning tool of claim 5, wherein:
the insertion tool also comprises a base; and
the storage receptacle is configured so that, when the storage receptacle receives and stores the insertion tool, at least a portion of the base remains outside of the storage receptacle.

7. The cleaning tool of claim 1, wherein the tube is integral with the handle.

8. The cleaning tool of claim 1, wherein the tube is less rigid than the handle.

9. The cleaning tool of claim 1, wherein the wipe comprises a microfiber cloth, an unbroken loop material, or a sheet of polyester, polypropylene, cotton, wood pulp, or rayon fibers.

10. The cleaning tool of claim 1, wherein the wipe comprises a spunbonded, non-woven polyester or polypropylene fabric with a continuous filament construction.

11. A kit comprising:
the cleaning tool of claim 1, wherein the tube is removably attached to the handle; and
one or more additional tubes, wherein each of the tubes differs from the other tubes in length and/or opening size.

12. The kit of claim 11, wherein each of the tubes is less rigid than the handle.

13. The kit of claim 11, further comprising a plurality of insertion tools, each of which comprises a pin sized to fit within at least one of the tubes.

14. The kit of claim 13, wherein:
the handle includes a first handle end for receiving each of the tubes; and
the handle also comprises a second handle end comprising an opening leading to a storage receptacle that is sized and configured to receive and store any of the insertion tools.

15. The kit of claim 14, wherein:
each insertion tool also comprises a base; and
the storage receptacle is configured so that, when the storage receptacle receives and stores any of the insertion tools, at least a portion of the base of that insertion tool remains outside of the storage receptacle.

16. The kit of claim 11, wherein the wipe comprises a microfiber cloth, an unbroken loop material, or a sheet of polyester, polypropylene, cotton, wood pulp, or rayon fibers.

17. The kit of claim 11, wherein the wipe comprises a spunbonded, non-woven polyester or polypropylene fabric with a continuous filament construction.

18. A method of using a cleaning tool, the method comprising:
grasping a handle of a cleaning tool that comprises:
the handle, and
a tube that:
extends from the handle at a first tube end, and
includes an opening that leads to an interior chamber at a second end that is opposite the first end;
inserting a first section of a cleaning wipe through the opening and into the chamber in an amount sufficient to secure the secure the wipe in place during use, while leaving a second section of the wipe positioned outside of the tube; and
applying the second section of the wipe to an item to clean the item.

19. The method of claim 18, wherein applying the second section of the wipe to the item comprises inserting the wipe and the second end of the tube into a chamber of the item.

20. The method of claim 19, wherein:
the first section of the wipe is a central area of the wipe;
the second section of the wipe surrounds the first section; and
inserting the first section of the wipe through the opening and into the chamber comprises using a pin of an insertion tool to push the first section of the wipe into the chamber.
